(19) United States
(12) Patent Application Publication
(10) Pub. No.: US 2024/0161020 A1
(43) Pub. Date: May 16, 2024

(54) APPARATUS AND METHOD FOR MANAGING BOOKING OF TRAVEL PRODUCTS

(71) Applicant: AX INC., Seoul (KR)

(72) Inventor: Yeonju OH, Seoul (KR)

(73) Assignee: AX INC., Seoul (KR)

(21) Appl. No.: 18/384,598

(22) Filed: Oct. 27, 2023

(30) Foreign Application Priority Data
Nov. 14, 2022 (KR) 10-2022 -0151710

(51) Int. Cl. G06Q 10/02; G06Q 50/14

(52) U.S. Cl. CPC G06Q 10/02; G06Q 50/14

(57) ABSTRACT

An apparatus for managing the booking of travel products includes memory storing booking-related information including information on a booking confirmation date, travel departure date, number of booking persons, number of persons who have confirmed a booking, and minimum number of departure persons of a travel product and a processor determining, based on the booking-related information, a first travel product that is ahead of a booking confirmation date thereof and in which the number of booking persons is less than a minimum number of departure persons and a second travel product that is ahead of a booking confirmation date thereof and in which the number of booking persons is a minimum number of departure persons or more, and providing a booking person of the second travel product with a booking change suggestion indicative of a booking change into the first travel product.

### TECHNICAL FIELD

The present disclosure relates to an apparatus and method for managing the booking of travel products and, more particularly, to an apparatus and method for managing the booking of travel products so that the inventory of a travel product can be efficiently managed.

### BACKGROUND ART

The demand for travel tends to be driven to a specific period or a specific day, such as a holiday or a rest day. In an online tour booking process, overbooking occurs because a system capable of updating the present booking condition (the present inventory condition) for a corresponding date in real time is not present. A travel agency does not have an inventory management system for each time slit, and many travel agencies also do not an online channel. Accordingly, the present inventory condition cannot be updated for each option in real time. As a result, a person must directly update the present inventory condition manually by hand.

A traveler is unaware of such a situation, and selects and buys a date and an option that have been opened on the basis of an online channel. If a travel agency has not updated an online channel with an option that is greater than a maximum number of persons, overbooking occurs.

In a travel product, it is difficult to flexibly adjust a maximum number of persons based on the number of booking persons. For example, it is difficult to flexibly adjust a bus tour because it is not easy to add a bus for the demand for a specific day.

As a result, overbooking is cancelled, and a traveler does not buy a travel product even if the traveler has booked the travel product. Accordingly, there are problems in that overbooking occurs on a day to which the demand for travel is driven, and a minimum number of departure persons are not met on other days. Accordingly, a travel agency misses a sales opportunity because the number of working days is reduced.

A travel agency previously cancels an option that is not greater than a minimum number of departure persons. That is, the reason for this is that it is difficult to manage a booking at a point of time close to the date of travel because the travel agency does not have a real-time inventory management system. Furthermore, it is difficult to keep alive an option that has not met a minimum number of departure persons because future demands are not predicted. Accordingly, the operation of a travel product is early cancelled. Such early operation cancellation results in the loss of a sales opportunity because a potential buyer is missed.

The above contents described in the Background technology are for helping the understanding of the Background of the present disclosure, and may include contents other than a disclosed conventional technology.

### SUMMARY OF INVENTION

### Technical Problem

Embodiments of the present disclosure provide an apparatus and method for managing the booking of travel products, which can increase the rate of operation of a travel product by efficiently managing the inventory of the travel product.

### Solution to Problem

An apparatus for managing the booking of travel products according to a preferred embodiment of the present disclosure may include memory configured to store booking-related information including information on a booking confirmation date, travel departure date, number of booking persons, number of persons who have confirmed a booking, and minimum number of departure persons of a travel product and a processor determining a first travel product that is ahead of a booking confirmation date thereof and in which the number of booking persons is less than a minimum number of departure persons based on the booking-related information, determining a second travel product that is ahead of a booking confirmation date thereof and in which the number of booking persons is a minimum number of departure persons or more based on the booking-related information, and providing a booking person of the second travel product with a booking change suggestion indicative of a booking change into the first travel product.

The processor may be configured to change the booking person of the second travel product into the number of booking persons for the first travel product, when receiving an acceptance signal for the booking change suggestion from the booking person of the second travel product.

The processor may be configured to provide a reward to a corresponding booking person who has accepted the booking change suggestion, when a booking confirmation date of the first travel product is reached and a current number of booking persons for the first travel product at the time of the booking confirmation date is the minimum number of departure persons or more.

The booking-related information may additionally include characteristic information for each travel product. The memory may be configured to additionally store booking person information and booking history information for each booking person.

The second travel product may be multiple. The processor may be configured to determine, as a first target, a booking person who is expected to have the highest possibility that the booking person is to accept the booking change suggestion based on information stored in the memory and to preferentially provide the booking change suggestion to the determined first target.

The processor may be configured to confirm characteristics of the first travel product, to confirm characteristics of each of booking persons of multiple second travel products, to determine similarity between the characteristics of the first travel product and the characteristics of each of the booking persons of the multiple second travel products, to determine suggestion ranking for the booking persons based on the determined similarity, and to provide the booking change suggestion to the booking person determined as the first target based on the determined suggestion ranking.

The processor may be configured to additionally incorporate a period between a travel departure date of the determined first travel product and a travel departure date of the determined second travel product into the determination of the suggestion ranking.

The first travel product may be multiple. The processor may be configured to determine a first travel product in which a current number of booking persons do not satisfy a minimum number of departure persons and a difference between the current number of booking persons and the minimum number of departure persons is a minimum, among the multiple first travel products.

The processor may be configured to inquire of a booking person of the determined first travel product about booking confirmation for the first travel product ahead of a booking confirmation date of the first travel product.

The processor may be configured to update the number of persons who have confirmed a booking about the first travel product, when receiving a signal indicative of the booking confirmation for the first travel product from the booking person of the first travel product.

The processor may be configured to provide a reward to a booking person who has accepted the booking confirmation when the booking confirmation date of the first travel product is reached and a current number of booking persons for the first travel product at the time of the booking confirmation date is a minimum number of departure persons or more.

A method of managing the booking of travel products according to a preferred embodiment of the present disclosure is a method performed by an apparatus for managing a booking of a travel product, and may include storing booking-related information including information on a booking confirmation date, travel departure date, number of booking persons, number of persons who have confirmed a booking, and minimum number of departure persons of a travel product, determining a first travel product that is ahead of a booking confirmation date thereof and in which the number of booking persons is less than a minimum number of departure persons based on the booking-related information, determining a second travel product that is ahead of a booking confirmation date thereof and in which the number of booking persons is a minimum number of departure persons or more based on the booking-related information, and providing a booking person of the second travel product with a booking change suggestion indicative of a booking change into the first travel product.

### Advantageous Effects of Invention

According to the present disclosure having such a construction, the number of booking persons for a first travel product can be additionally secured more easily because a booking change suggestion indicative of a booking change into the first travel product that is ahead of a booking confirmation date thereof and in which the number of booking persons is less than a minimum number of departure persons can be provided to the booking person of the second travel product that is ahead of the booking confirmation date and in which the number of booking persons is the minimum number of departure persons or more.

The state of many travel products can be rapidly changed into a departure-confirmable state or a departure confirmation state due to such a booking change suggestion.

Furthermore, a sales opportunity can be provided because larger departure confirmation-possible travel products or departure confirmation travel products can be generated to meet the needs of potential buyers.

A travel agency can optimize sales and develop a predictable strategy.

A sales opportunity can be extended and a sales occurrence opportunity can be increased with respect to a potential buyer because the days of operations by unit period are increased.

A predictable sales strategy can be developed because a travel product having a departure confirmation state can be secured in advance. Accordingly, operation costs can be minimized.

An additional effect, such as a sales increase, can be obtained because a tour or a company is recognized and branded as having a high rate of operation within the market.

Furthermore, the possibility that a traveler fails in experiencing a desired experience product is reduced.

Sales can be increased because the frequent cancellation of booking and a booking bias phenomenon can be prevented.

### BRIEF DESCRIPTION OF DRAWINGS

FIG. 1 is a construction diagram of a system to which an apparatus for managing the booking of travel products according to an embodiment of the present disclosure has been applied.

FIG. 2 is a diagram for describing travel products in an embodiment of the present disclosure.

FIG. 3 is an internal construction diagram of a management server illustrated in FIG. 1.

FIGS. 4 and 5 are flowcharts for describing a method of managing the booking of travel products according to an embodiment of the present disclosure.

FIG. 6 is a flowchart for more specifically describing a step of transmitting a booking change suggestion in the method of managing the booking of travel products according to an embodiment of the present disclosure.

### DESCRIPTION OF EMBODIMENTS

The present disclosure may be changed in various ways and may have various embodiments. Specific embodiments are to be illustrated in the drawings and specifically described.

It should be understood that the present disclosure is not intended to be limited to the specific embodiments, but includes all of changes, equivalents and/or substitutions included in the spirit and technical range of the present disclosure.

Terms used in the present application are used to merely describe specific embodiments and are not intended to restrict the present disclosure. An expression of the singular number includes an expression of the plural number unless clearly defined otherwise in the context. In the present application, it is to be understood that a term, such as “include” or “have”, is intended to designate that a characteristic, a number, a step, an operation, a component, a part or a combination of them described in the specification is present, and does not exclude the presence or addition possibility of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification. Terms, such as those defined in commonly used dictionaries, should be construed as having the same meanings as those in the context of a related technology, and are not construed as ideal or excessively formal meanings unless explicitly defined otherwise in the specification.

Hereinafter, preferred embodiments of the present disclosure are more specifically described with reference to the accompanying drawings. In describing the present disclosure, in order to help general understanding, the same reference numerals are used to denote the same components throughout the drawings, and a redundant description of the same components is omitted.

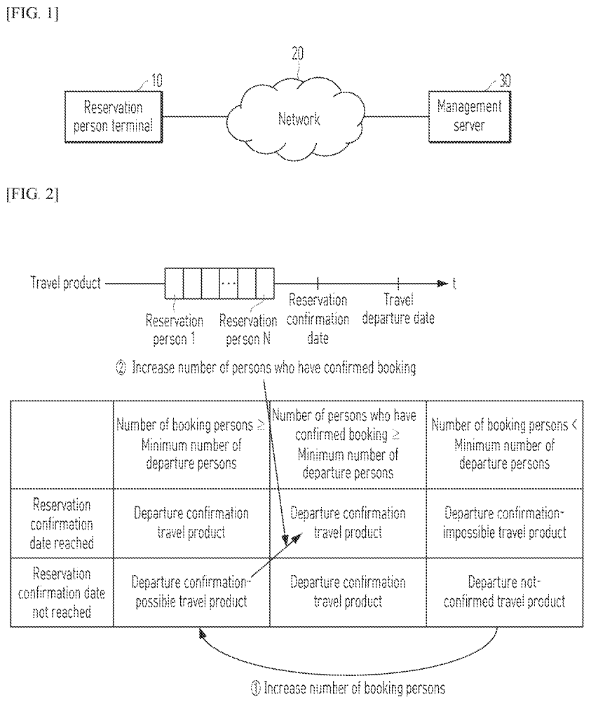

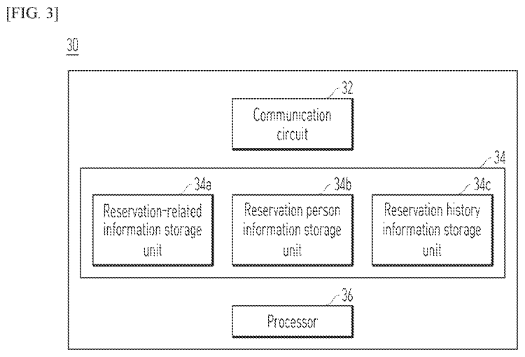

FIG. 1 is a construction diagram of a system to which an apparatus for managing the booking of travel products according to an embodiment of the present disclosure has been applied. FIG. 2 is a diagram for describing travel products in an embodiment of the present disclosure.

The system in FIG. 1 may include a booking person terminal 10, a network 20, and a management server 30.

The booking person terminal 10 is a terminal capable of booking and buying a travel product.

In this case, the travel product may mean a product that provides travel experiences including travel (or tour) and activities.

For example, a booking person of the booking person terminal 10 may book and buy a travel product through an online channel (or an online platform).

The booking person terminal 10 may access the management server 30, and may select, book, and buy a desired travel product or inquire about a travel product on a desired travel departure date.

The booking person terminal 10 may receive information (e.g., a date of birth, a gender, or an address) on a corresponding booking person. The information on the booking person may be input through a direct key input by a corresponding booking person.

The booking person terminal 10 may transmit, to the management server 30, information (e.g., a travel product name or a booked amount) corresponding to a travel product when the travel product is booked.

The booking person terminal 10 may check (or inquire about) information, such as booking confirmation dates and travel departure dates for various types of travel products.

The booking person terminal 10 may be implemented as a computer capable of accessing the management server 30 over the network 20. In this case, the computer may include a notebook, a desktop, and a laptop to which a web browser has been mounted, for example.

Furthermore, the booking person terminal 10 may be implemented as a terminal device capable of accessing the management server 30 over the network 20. The terminal device is a wireless communication device for which portability and mobility are guaranteed, for example, and may include all types of handheld-based wireless communication devices, such as a personal communication system (PCS), a global system for mobile communications (GSM), personal digital cellular (PDC), a personal handyphone system (PHS), a personal digital assistant (PDA), International Mobile Telecommunication (IMT)-2000, code division multiple access (CDMA)-2000, w-code division multiple access (W-CDMA), a wireless broadband Internet (Wibro) terminal, a smartphone, a smartpad, and a tablet PC.

FIG. 1 illustrates only one booking person terminal 10, but it should be understood that multiple booking person terminals 10 are actually present.

The network 20 may mean a connection structure through which nodes, such as the booking person terminal 10 and the management server 30, can exchange information.

For example, the network 20 using a wireless communication method may include a wireless LAN (WLAN), wireless broadband (Wibro), wideband CDMA (WCDMA), IEEE 802.16, long term evolution (LTE), long term evolution-advanced (LTE-A), Bluetooth, radio frequency identification (RFID), infrared data association (IrDA), ultra-wideband (UWB), ZigBee, near field communication (NFC), ultra sound communication (USC), visible light communication (VLC), and Wi-Fi, but the present disclosure is not limited thereto.

The network 20 using a wired communication method may include a wired local area network (LAN), a wired wide area network (WN), power line communication (PLC), USB communication, Ethernet, serial communication, and optical/coaxial cable communication, but the present disclosure is not limited thereto.

The management server 30 may store booking-related information, booking person information, and booking history information.

The management server 30 may classify a state for each travel product. The state for each travel product may be classified based on a degree of booking about a corresponding travel product. The management server 30 may classify a travel product as any one of a departure not-confirmed travel product, a departure confirmation travel product, and a departure confirmation-impossible travel product. State information for each travel product may be updated from a current state to another state.

As illustrated in FIG. 2, an arbitrary travel product P has a booking confirmation date and a travel departure date. The booking confirmation date is a date prior to the travel departure date, and may be a date that is two days ahead of the travel departure date, for example.

When the booking confirmation date of the travel product P is reached, all bookings that have been maintained meanwhile are changed into booking confirmation. That is, as illustrated in FIG. 2, several booking persons booking person1 to booking personN may book the travel product P. When the booking confirmation date is reached, all bookings (e.g., the bookings of the booking person1, the booking person2, the booking person5, and the booking person8) that have been maintained up to the booking confirmation date (i.e., the bookings have not been cancelled) are changed into booking confirmation. After the bookings are changed into the booking confirmation as described above, although the booking is cancelled, there is no refund amount. If the booking is cancelled before the booking confirmation date, there may be a predetermined refund amount.

The management server 30 may classify a travel product that has reached a booking confirmation date and in which the current number of booking persons is smaller than a minimum number of departure persons as a departure confirmation-impossible travel product. That is, when the booking confirmation date is reached, all bookings that have been maintained at the time of the booking confirmation date are changed into booking confirmation. The current number of booking persons may be understood as the current number of persons who have confirmed a booking. Such a departure confirmation-impossible travel product cannot be operated because the current number of booking persons is smaller than the minimum number of departure persons although the booking confirmation date has been reached.

The management server 30 may classify a travel product that has not reached a booking confirmation date and in which the number of booking persons is less than a minimum number of departure persons as a departure not-confirmed travel product. The management server 30 will wait up to the booking confirmation date with respect to the departure not-confirmed travel product, and will then change the departure not-confirmed travel product into a departure confirmation travel product or a departure confirmation-impossible travel product depending on which the number of booking persons at the time of the booking confirmation date satisfies the minimum number of departure persons.

The management server 30 may classify a travel product that has not reached a booking confirmation date and in which the number of booking persons is a minimum number of departure persons or more as a departure confirmation-possible travel product. The management server 30 will wait up to the booking confirmation date with respect to the departure confirmation-possible travel product, and will then change the departure confirmation-possible travel product into a departure confirmation travel product or a departure confirmation-impossible travel product depending on whether the number of booking persons at the time of the booking confirmation date satisfies the minimum number of departure persons.

Furthermore, the management server 30 may classify a travel product that has not reached a booking confirmation date and in which the number of persons who have confirmed a booking is a minimum number of departure persons or more as a departure confirmation travel product.

The management server 30 may classify a travel product that has reached a booking confirmation date and in which the number of booking persons is a minimum number of departure persons or more as a departure confirmation travel product.

Furthermore, the management server 30 may classify a travel product that has reached a booking confirmation date and in which the number of persons who have confirmed a booking is a minimum number of departure persons or more as a departure confirmation travel product.

The departure confirmation travel product is a travel product whose operation has been confirmed because the minimum number of departure persons for the departure confirmation travel product has been secured, and may mean a travel product whose itinerary can be started when a travel departure date is reached.

The management server 30 may include state information (e.g., one of a departure not-confirmed travel product, a departure confirmation travel product, and a departure confirmation-impossible travel product) for each travel product in booking-related information.

The management server 30 may determine (or search for) a first travel product that is ahead of a booking confirmation date thereof (i.e., the booking confirmation date has not been reached) and in which the number of booking persons is less than a minimum number of departure persons based on booking-related information. Here, the first travel product that has been determined (or searched for) is a departure not-confirmed travel product. One or more first travel products may be determined (searched for). In this case, the management server 30 determines (or searches for) the first travel product (i.e., a departure not-confirmed travel product) in which the current number of booking persons has not satisfied the minimum number of departure persons and a difference between the current number of booking persons and the minimum number of departure persons is a minimum, among multiple departure not-confirmed travel products.

The management server 30 may inquire of a booking person of the first travel product that has been determined (or searched for) about booking confirmation for the first travel product. That is, the management server 30 may inquire about the booking confirmation for the first travel product in the state in which a booking confirmation date of the first travel product has not been reached.

For example, the inquiry about the booking confirmation may include contents that inquire about whether to change a booking about the first travel product into booking confirmation although a booking confirmation date of the first travel product has not been reached. The inquiry about the booking confirmation is for previously securing the number of persons who have confirmed a booking. Furthermore, the management server 30 may easily check how many persons for the booking are required in order for the first travel product to be changed into a departure confirmation-possible travel product or a departure confirmation travel product, based on a reply (e.g., acceptance or non-acceptance) to the inquiry about the booking confirmation. The number of persons who have confirmed a booking, which has been secured ahead of the booking confirmation date, is included in the number of booking persons because the number of persons who have confirmed a booking is a booking person before the booking confirmation date is reached.

A departure not-confirmed travel product is changed into a departure confirmation-impossible travel product when the number of booking persons is less than a minimum number of departure persons although a booking confirmation date is reached. Accordingly, it is better that the departure not-confirmed travel product is changed into a departure confirmation-possible travel product in which the number of booking persons is the minimum number of departure persons or more before the booking confirmation date is reached.

In order to promote a change from a travel product in which the number of booking persons is less than a minimum number of departure persons to a departure confirmation-possible travel product in which the number of booking persons is the minimum number of departure persons or more, the management server 30 may provide a reward to a booking person of a first travel product who has accepted booking confirmation for the first travel product. Furthermore, the management server 30 may also provide a description of the reward which may be provided when the booking person of the first travel product accepts the booking confirmation while inquiring of the person about the booking confirmation for the first travel product.

The reward may be provided when a first travel product (e.g., a departure not-confirmed travel product) is changed into a departure confirmation-possible travel product or may be provided when the first travel product is changed into a departure confirmation travel product. Most preferably, it is better to provide the reward when the first travel product is changed into the departure confirmation travel product. The reward may include a reduction in a booking amount for the first travel product (e.g., a refund or a discount) or a discount coupon of a predetermined amount, which may be used at a travel destination of the first travel product, for example. As described above, if some of the booking amount for the first travel product is refunded as the reward or the discount coupon which may be used at the travel destination of the first travel product is provided as the reward, there is an effect in that the reward contributes to economic vitalization at the travel destination. Furthermore, the reward may help to prevent a booking person of the first travel product from leaving booking of the first travel product. The reward may also include an airfare discount (ticket) or an accommodation cost discount (ticket) instead of the discount coupon, if necessary.

According to embodiments, the management server 300 may register some of booking persons of the first travel product with a reward provision target list, and may lower a booking amount included in booking history information of the booking person, that is, a reward provision target, with reference to the reward provision target list or may transmit, to the terminals of reward provision targets, information on discount coupons corresponding to reward amounts.

The management server 30 may receive information including a reply to an inquiry about booking confirmation from the booking person terminal 10, and may update the number of persons who have confirmed a booking about the first travel product based on the received information. The number of persons who have confirmed a booking, which was previously updated, may be considered as the number of booking persons for the first travel product because the booking confirmation date of the first travel product has not been reached. If a booking person who has accepted booking confirmation subsequently cancels a confirmed booking in the state in which the booking confirmation date of the first travel product has not been reached, the management server 30 may impose a predetermined penalty on the booking person.

The management server 30 may determine (or search for) a second travel product that is ahead of a booking confirmation date (i.e., a booking confirmation date has not been reached) thereof and in which the number of booking persons is a minimum number of departure persons or more based on booking-related information. In this case, the second travel product that is determined (or searched for) is a departure confirmation-possible travel product, and one or more second travel products may be determined (searched for). Furthermore, it is better that a travel departure date of the second travel product that has been determined (or searched for) does not have a great difference from the travel departure date of the first travel product that was previously determined (or searched for).

The management server 30 may provide a booking change suggestion indicative of a booking change into the first travel product that was previously determined (or searched for) to a booking person of the second travel product. In this case, a travel product may be changed into a departure confirmation-possible travel product by increasing the number of booking persons from the travel product in which the current number of booking persons does not satisfy a minimum number of departure persons and a difference between the current number of booking persons and the minimum number of departure persons is a minimum, among multiple first travel products.

In particular, the management server 30 may determine, as a first target, a booking person (i.e., a booking person of the second travel product) who is expected to have the highest possibility that the booking person will accept a booking change suggestion, based on information stored in internal memory of the management server 30. The management server 30 may provide the booking change suggestion to the determined first target. According to embodiments, the management server 30 confirms characteristics of a first travel product (e.g., a departure not-confirmed travel product) and characteristics of booking persons of multiple second travel products (e.g., departure confirmation-possible travel products) based on information stored in the internal memory. The management server 30 determines similarity between the characteristics of the first travel product and the characteristics of the booking persons of the multiple second travel products. That is, the management server 30 may determine a degree that each of the booking persons of the multiple second travel products is matched with the characteristics of the first travel product. The management server 30 determines suggestion ranking based on the similarity. The management server 30 transmits a booking change suggestion to the booking person of the second travel product based on the suggestion ranking. That is, the management server 30 first transmits the booking change suggestion to a booking person of the second travel product, which has the highest similarity. In this case, the probability that a booking person will accept a booking change is increased because the booking change suggestion is sequentially provided from a booking person who has the highest possibility that the booking person will accept the booking change suggestion. It is not necessary to thoughtlessly transmit the booking change suggestion to many booking persons at the same time.

In order to promote a change from a travel product in which the number of booking persons is less than a minimum number of departure persons to a departure confirmation-possible travel product in which the number of booking persons is the minimum number of departure persons or more, the management server 30 may provide a reward to a booking person of the second travel product, who has accepted the booking change from the second travel product to the first travel product. Furthermore, the management server 30 may also provide a description of the reward, which may be provided when the booking person accepts the booking change, while inquiring of the booking person of the second travel product about the booking change into the first travel product.

Since the booking person has helped to change the travel product (i.e., the first travel product) which may be cancelled into the departure confirmation-possible travel product, the management server 30 may provide the predetermined reward to the corresponding booking person as a benefit in return. If timing at which the booking change is made is ahead of a booking confirmation date (i.e., a booking confirmation date has not been reached) of the second travel product, the management server 30 may provide the reward to the booking person by allowing the booking person to book the first travel product at a lower price (or a booking amount) than the second travel product that was booked by the booking person. If the timing at which the booking change is made is behind the booking confirmation date (i.e., the booking confirmation date has been reached) of the second travel product, the management server 30 may provide the booking person with the reward that refunds some of the booking amount of the second travel product.

According to embodiments, the management server 30 may register a booking person (e.g., a booking person who has made a booking change into the first travel product), among the booking persons of the second travel product, with a reward provision target list, and may lower a booking amount included in booking history information of the booking person, that is, a reward provision target, with reference to the reward provision target list or may transmit information on a discount coupon corresponding to the amount of the reward to the terminal of the reward provision target.

The management server 30 may receive intention of acceptance to the booking change suggestion for the first travel product from the booking person terminal 10 of the second travel product.

The management server 30 may change the booking person of the second travel product, who has accepted the booking change into the first travel product, into the number of booking persons for the first travel product. In this case, the number of booking persons for the second travel product may become less than a minimum number of departure persons due to the acceptance of the booking change into the first travel product. In order to prevent such a case, for example, assuming that there is a second travel product in which a minimum number of departure persons is 10 and the current number of booking persons is 13, the management server 30 may process the acceptance of a booking change from 3 booking persons.

Thereafter, when a booking confirmation date of a first travel product (e.g., a departure not-confirmed travel product) is reached, the management server 30 may determine whether the current number of booking persons for the first travel product has satisfied a minimum number of departure persons of the first travel product.

If the booking confirmation date has been reached, but the minimum number of departure persons has not been satisfied based on the results of the determination, the management server 30 changes the first travel product into a departure confirmation-impossible travel product. In this case, since the departure confirmation-impossible travel product does not have an effective value as a travel product, the management server 30 will cancel (or discard) the departure confirmation-impossible travel product.

If the booking confirmation date has been reached and the minimum number of departure persons has been satisfied based on the results of the determination, the management server 30 changes the first travel product into a departure confirmation-possible travel product.

The management server 30 may provide a predetermined reward to the booking person of the second travel product, who has accepted a booking change into the first travel product because the first travel product (i.e., a departure not-confirmed travel product) is changed into the departure confirmation-possible travel product. The management server 30 may provide a predetermined reward to a booking person who has confirmed the booking of the first travel product in the state in which the booking confirmation date of the first travel product has not been reached.

The management server 30 may determine (or search for) a second travel product (e.g., a departure confirmation-possible travel product) that is ahead of a booking confirmation date thereof and in which the number of booking persons is a minimum number of departure persons or more, based on booking-related information, and may inquire of a booking person of the determined second travel product about booking confirmation for the second travel product prior to the booking confirmation date. If the number of second travel products that have been determined (or searched for) is several, the management server 30 may inquire of each of booking persons of the second travel products about booking confirmation for the second travel products.

For example, the inquiry of the booking person of the second travel product about the booking confirmation may include contents that inquire about whether to change a booking about the second travel product into booking confirmation although the booking confirmation date of the second travel product has not been reached. Such inquiry about the booking confirmation is to previously secure the number of persons who have confirmed a booking. In order for a travel product to become a departure confirmation travel product, the number of persons who have confirmed a booking of the travel product needs to be a minimum number of departure persons or more. Accordingly, it is better to previously secure the number of persons who have confirmed a booking in terms of the management of the travel product.

The inquiry of the booking person of the second travel product about the booking confirmation may include a description of a reward that will be provided when the booking person accepts the booking confirmation. The reward may be provided when the second travel product is changed into a departure confirmation-possible travel product. The reward may include refunding some of a booking amount of the second travel product.

The management server 30 may receive information including a reply to the inquiry about the booking confirmation from the booking person terminal 10, and may update the number of persons who have confirmed a booking of the second travel product (e.g., a departure confirmation-possible travel product) based on the received information.

Furthermore, the management server 30 may provide a predetermined reward to a booking person who has accepted the booking confirmation for the second travel product (e.g., the departure confirmation-possible travel product) ahead of the booking confirmation date of the second travel product.

The management server 30 may impose a predetermined penalty on a booking person if the booking person who has accepted booking confirmation cancels a confirmed booking subsequently (e.g., before the booking confirmation date of the second travel product is reached or after the booking confirmation date of the second travel product is reached) in the state in which the booking confirmation date of the second travel product has not been reached.

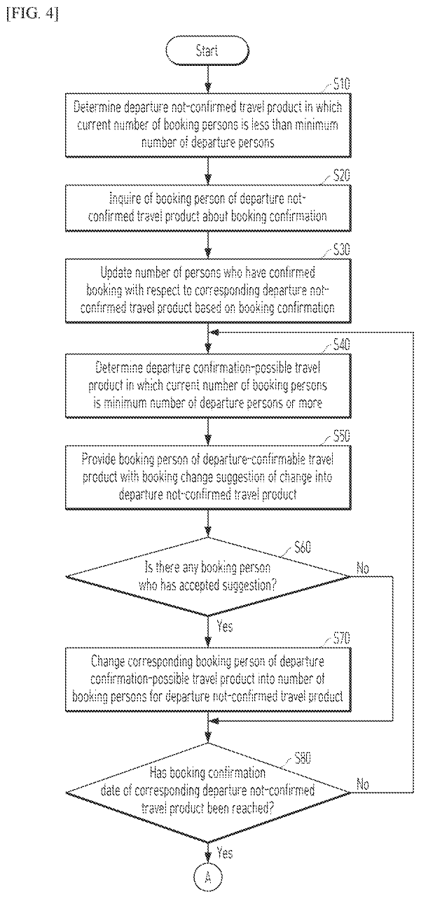

FIG. 3 is an internal construction diagram of the management server 30 illustrated in FIG. 1.

The management server 30 may include a communication circuit 32, memory 34, and a processor 36.

The communication circuit 32 may exchange data with the booking person terminal 10. According to embodiments, the communication circuit 32 may exchange data with the booking person terminal 10 by using the wireless communication method or the wired communication method.

The memory 34 may store data that are necessary for an operation of the management server 30.

Furthermore, the memory 34 may store a program including instructions for performing a series of operation that are performed by the management server 30.

The memory 34 may include a nonvolatile memory device or a volatile memory device. According to embodiments, the memory 34 may be constructed by being included in the processor 36, but the present disclosure is not limited thereto.

The memory 34 may include a booking-related information storage unit 34a, a booking person information storage unit 34b, and a booking history information storage unit 34c.

The booking-related information storage unit 34a may store booking-related information.

In this case, the booking-related information may include predetermined information for each travel product. For example, the booking-related information may include a travel product name, a booking date and time, a booking schedule, the number of booking persons, a booking confirmation date, the number of persons who have confirmed a booking, a minimum number of departure persons, and a travel departure date for each travel product. The travel product name may mean a name which may specify a corresponding travel product. The booking date and time may mean a date and time on which a corresponding travel product has been booked. The booking schedule may mean a daily schedule of a corresponding travel product and/or a schedule for each time zone. The number of persons for booking may mean the number of booking persons who have booked a corresponding travel product prior to a booking confirmation date of the corresponding travel product. The number of booking persons may be changed in real time because the booking and the cancellation of the booking may frequently occur prior to a booking confirmation date. The booking confirmation date may mean a date that is several days ahead of a travel departure date. The number of persons who have confirmed a booking may mean the number of booking persons at the time of a booking confirmation date. That is, the number of persons who have confirmed a booking may mean the number of booking persons who have maintained a booking about a corresponding travel product without any change prior to a booking confirmation date. The minimum number of departure persons may mean a minimum number of persons for sales that are more than operation costs for a travel product. When the number of persons who have confirmed a booking is less than a minimum number of departure persons, a loss will occur whenever a corresponding travel product is operated. The travel departure date may mean a date when a corresponding travel product starts to operate.

The booking-related information may additionally include characteristic information for each travel product, if necessary. For example, the characteristic information for each travel product may be information indicative of the attributes of a travel product, such as activities, hiking, watching, walking, a train, and a bicycle. In this case, the characteristic information for each travel product may be previously designated by a travel agency.

Furthermore, the booking-related information may additionally include state information for each travel product. For example, the state information for each travel product may be any one of a departure not-confirmed travel product, a departure confirmation travel product, and a departure confirmation-impossible travel product.

The booking person information storage unit 34b may store booking person information.

In this case, the booking person information may include information on a date of birth, gender, or place of residence of a booking person.

The booking history information storage unit 34c may store booking history information for each booking person.

In this case, the booking history information may include information related to a booking about a travel product for each booking person. For example, the booking history information may include information (e.g., a travel area, the number of travel persons, a travel period, and a travel theme) related to a travel product that is booked by a booking person, a booking amount at the time of a booking about a travel product, and information on a booking time and grade.

The processor 36 may control overall operations of the management server 30. According to embodiments, the processor 36 may execute a program (or an application) including at least one instruction stored in the memory 34, and may control an operation of the management server 30 by performing operations corresponding to the program based on the results of the execution.

For example, the processor 36 may include integrated circuit elements, such as a central processing unit (CPU), a graphical processing unit (GPU), an application specific integrated circuit (ASIC), a field programmable gate array (FPGA), and a micro controller unit (MCU), but the present disclosure is not limited thereto.

The processor 36 may determine a state for each travel product. According to embodiments, the processor 36 may classify a travel product as any one of a departure not-confirmed travel product, a departure confirmation travel product, and a departure confirmation-impossible travel product in real time. The processor 36 stores such state information for each travel product in the memory 34.

The processor 36 may determine (or search for) a first travel product that is ahead of a booking confirmation date thereof and in which the number of booking persons is less than a minimum number of departure persons (e.g., a departure not-confirmed travel product) based on booking-related information. In this case, several departure not-confirmed travel products may be searched for. Accordingly, the processor 36 preferentially determines (or searches for) a departure not-confirmed travel product in which the current number of booking persons does not satisfy a minimum number of departure persons and a difference between the current number of booking persons and the minimum number of departure persons is a minimum, among departure not-confirmed travel products.

The processor 36 may inquire of a booking person of a first travel product that has been determined (or searched for) about a booking confirmation for the first travel product through the communication circuit 32. In this case, the processor 36 may inquire about the booking confirmation for the first travel product in the state which a booking confirmation date of the first travel product has not been reached. For example, the inquiry about the booking confirmation may include contents that inquire about whether to change the booking about the first travel product into the booking confirmation although the booking confirmation date of the first travel product has not been reached. The inquiry about the booking confirmation may include a description of a reward that is provided when the booking person accepts the booking confirmation.

The processor 36 may receive information including a reply to the inquiry about the booking confirmation from the booking person terminal 10, and may update the number of persons who have confirmed a booking of the first travel product based on the received information. The number of persons who have confirmed a booking, which was previously updated in the state in which the booking confirmation date of the first travel product has not been reached, may be considered as the number of booking persons for the first travel product. The processor 36 may impose a predetermined penalty on a booking person if the booking person who has accepted booking confirmation subsequently cancels a confirmed booking in the state in which the booking confirmation date of the first travel product has not been reached.

The processor 36 may determine (or search for) a second travel product that is ahead of a booking confirmation date (i.e., the booking confirmation date has not been reached) thereof and in which the number of booking persons is a minimum number of departure persons or more based on booking-related information. In this case, the second travel product that has been determined (or searched for) is a departure confirmation-possible travel product. One or more second travel products may be determined (searched for).

The processor 36 may provide a booking person of the second travel product with a booking change suggestion indicative of a booking change into the first travel product that was previously determined (or searched for) through the communication circuit 32.

If multiple second travel products have been determined (or searched for), the processor 36 may preferentially provide a booking change suggestion to a booking person (i.e., the booking person of the second travel product) who is expected to have the highest possibility that the booking person will accept the booking change suggestion.

In other words, the processor 36 may determine, as a first target, the booking person who is expected to have the highest possibility that the booking person will accept the booking change suggestion, based on information stored in the memory 34. The processor 36 may provide the determined first target with the booking change suggestion through the communication circuit 32. According to embodiments, the processor 36 confirms characteristics of a first travel product (e.g., a departure not-confirmed travel product) and characteristics (e.g., information on which which travel product is basically booked) of booking persons of multiple second travel products (e.g., departure confirmation-possible travel products), based on information stored in the memory 34. The processor 36 determines similarity between the characteristics of the first travel product and the characteristics of each of the booking persons of the multiple second travel products. That is, the processor 36 may determine a degree that the characteristics of the first travel product are matched with each of the booking persons of the multiple second travel products. Accordingly, the processor 36 determines suggestion ranking based on the similarity. It is better that a travel departure date of the second travel product does not have a great difference from a travel departure date of the first travel product. Accordingly, the processor 36 may also incorporate a period between the travel departure date of the second travel product and the travel departure date of the first travel product into the determination of the suggestion ranking. For example, the processor 36 may assign a higher weight as the period between the travel departure date of the second travel product and the travel departure date of the first travel product is reduced. The processor 36 may transmit the booking change suggestion to the booking person of the second travel product based on the suggestion ranking. That is, the processor 36 determine the booking person of the second travel product having the highest similarity as the first target, and first transmits the booking change suggestion to the first target.

The booking change suggestion may include a description of a reward that is provided when the booking person of the second travel product accepts the booking change suggestion.

The processor 36 may receive intention of acceptance to the booking change suggestion for the first travel product from the booking person terminal 10 of the second travel product through the communication circuit 32.

The processor 36 may change a corresponding booking person of the second travel product, who has accepted the booking change into the first travel product, into the number of booking persons for the first travel product. In this case, the number of booking persons for the second travel product may become less than a minimum number of departure persons of the second travel product because the booking person of the second travel product (e.g., a departure confirmation-possible travel product) accepts the booking change into the first travel product. In order to prevent such a case, for example, assuming that there is a second travel product in which a minimum number of departure persons is 20 and the current number of booking persons is 25, the processor 36 may recognize only the acceptance of a booking change up to 5 booking persons.

The processor 36 may determine whether the current number of booking persons for a first travel product (e.g., a departure not-confirmed travel product) the booking confirmation date of which has been reached satisfies a minimum number of departure persons of the first travel product.

If the booking confirmation date has been reached, but the minimum number of departure persons has not been satisfied based on the results of the determination, the processor 36 changes the first travel product into a departure confirmation-impossible travel product. In this case, the departure confirmation-impossible travel product does not have an effective value as a travel product. Accordingly, the processor 36 will cancel (or discard) the departure confirmation-impossible travel product.

If the booking confirmation date has been reached and the minimum number of departure persons has been satisfied based on the results of the determination, the processor 36 changes the first travel product into a departure confirmation-possible travel product.

As the first travel product (i.e., the departure not-confirmed travel product) is changed into the departure confirmation-possible travel product, the processor 36 may provide a predetermined reward to a corresponding booking person of the second travel product, who has accepted the booking change into the first travel product. In this case, if the current number of booking persons for the first travel product at the time of the booking confirmation date thereof is a minimum number of departure persons or more because the booking confirmation date of the first travel product has been reached, it is better to provide the reward to a corresponding booking person who has accepted a booking change suggestion. In this case, the reward may be a reward on which the corresponding booking person can book the first travel product at a price (i.e., a booking amount) lower than a fixed price (or basic price) for the second travel product when timing at which the booking change is made is ahead of a booking confirmation date (i.e., the booking confirmation date has not been reached) of the second travel product. The reward may be a reward that refunds some of the booking amount of the second travel product when timing at which the booking change is made is behind the booking confirmation date (i.e., the booking confirmation date has been reached) of the second travel product.

The processor 36 may also provide a predetermined reward to a booking person who has confirmed the booking of the first travel product in the state in which the booking confirmation date of the first travel product has not been reached. In this case, if the booking confirmation date of the first travel product has been reached and the current number of booking persons for the first travel product at the time of the booking confirmation date thereof is the minimum number of departure persons or more, it is better to provide the reward to the booking person who has accepted the booking confirmation. In this case, the reward may include refunding some of a booking amount for the first travel product or a discount coupon having a predetermined amount, which may be used at a travel destination of the first travel product, for example.

The processor 36 may determine (or search for) a second travel product (e.g., a departure confirmation-possible travel product) that is ahead of a booking confirmation date thereof and in which the number of booking persons is a minimum number of departure persons or more, based on booking-related information, and may inquire of a booking person of the determined second travel product about booking confirmation for the second travel product.

For example, the inquiry of the booking person of the second travel product about the booking confirmation may include contents that inquire about whether to change the booking about the second travel product into the booking confirmation although the booking confirmation date of the second travel product has not been reached.

The inquiry of the booking person of the second travel product about the booking confirmation may include a description of a reward that is provided when the booking person accepts the booking confirmation.

The processor 36 may determine the amount (or sum) of the reward based on a margin (or profit) for a booked product, the price (or booking amount) of the booked product, a remaining period up to a booking confirmation date, the number of targets who have transmitted a request for a booking change (or booking confirmation), a difference between the number of persons who have confirmed a booking and a minimum number of departure persons, and the current number of persons who have confirmed a booking.

The processor 36 may receive information including a reply to the inquiry about the booking confirmation through the communication circuit 32 from the booking person terminal 10, and may update the number of persons who have confirmed a booking about the second travel product based on the received information. The processor 36 may impose a predetermined penalty on the booking person of the second travel product if the booking person who has accepted the booking confirmation subsequently cancels the confirmed booking in the state in which the booking confirmation date of the second travel product has not been reached.

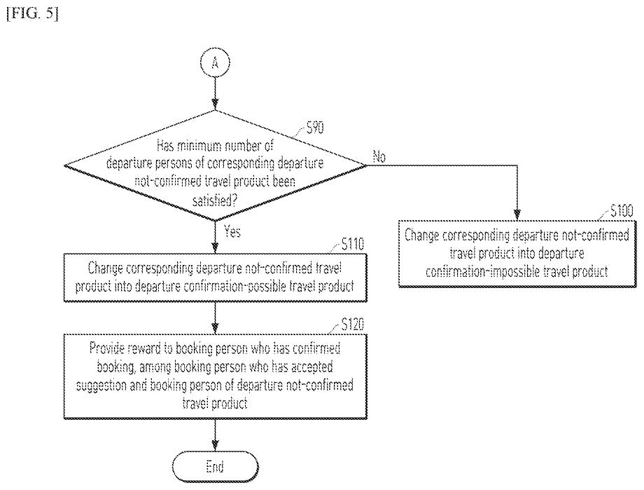

FIGS. 4 and 5 are flowcharts for describing a method of managing the booking of travel products according to an embodiment of the present disclosure.

The management server 30 determines (or searches for) a first travel product that is ahead of a booking confirmation date (i.e., the booking confirmation date has not been reached) thereof and the number of booking persons is less than a minimum number of departure persons, based on booking-related information stored in the memory 34 (S10). In this case, the first travel product that has been determined (or searched for) is a departure not-confirmed travel product, and one or more first travel products may be determined (searched for). In this case, the management server 30 may preferentially determine (or search for) a departure not-confirmed travel product in which the current number of booking persons does not satisfy the minimum number of departure persons and a difference between the current number of booking persons and the minimum number of departure persons is a minimum, among multiple departure not-confirmed travel products.

Thereafter, the management server 30 may inquire of a booking person of the first travel product that has been determined (or searched for) about booking confirmation for the first travel product (S20). The inquiry about the booking confirmation is for previously securing the number of persons who have confirmed a booking. Furthermore, the inquiry about the booking confirmation is for easily checking how many persons for the booking are required in order for the first travel product to be changed into a departure confirmation-possible travel product or a departure confirmation travel product, based on a reply (e.g., acceptance or non-acceptance) to the inquiry about the booking confirmation.

The management server 30 receives information including a reply (e.g., acceptance or non-acceptance) to the inquiry about the booking confirmation from the booking person terminal 10, and updates the number of persons who have confirmed the booking about the first travel product, based on the received information (S30). In this case, the number of persons who have confirmed a booking, which was secured ahead of the booking confirmation date may be considered as being included in the number of booking persons because the number of persons who have confirmed the booking is a booking person before the booking confirmation date is reached.

The management server 30 determines (or searches for) a second travel product that is ahead of a booking confirmation date (i.e., the booking confirmation date has not been reached) thereof and in which the number of booking persons is a minimum number of departure persons or more, based on the booking-related information (S40).

The management server 30 provides a booking person of the second travel product with a booking change suggestion indicative of a booking change into the first travel product (S50). In this case, it is preferred that the first travel product is a travel product in which the current number of booking persons does not satisfy a minimum number of departure persons and is a travel product in which a difference between the current number of booking persons and the minimum number of departure persons is a minimum.

When receiving intention of acceptance to the booking change suggestion into the first travel product from the booking person terminal 10 of the second travel product (“Yes” in S60), the management server 30 changes the booking person of the second travel product who has accepted the booking change into the first travel product as the number of booking persons for the first travel product (S70). In this case, the number of booking persons for the second travel product may become less than the minimum number of departure persons of the second travel product because the booking person of the second travel product (e.g., a departure confirmation-possible travel product) accepts the booking change into the first travel product. In order to prevent such a case, assuming that there is a second travel product in which a minimum number of departure persons is 10 and the current number of booking persons is 13, for example, the management server 30 may recognize only the acceptance of a booking change up to three booking persons.

Thereafter, when the booking confirmation date of the first travel product (e.g., a departure not-confirmed travel product) is reached (“Yes” in S80), the management server 30 determines whether the current number of booking persons for the first travel product satisfies the minimum number of departure persons of the first travel product (S90).

If the booking confirmation date of the first travel product has been reached, but the minimum number of departure persons has not been satisfied, the management server 30 changes the first travel product into a departure confirmation-impossible travel product (S100).

In contrast, if the booking confirmation date of the first travel product has been reached and the minimum number of departure persons has been satisfied, the management server 30 changes the first travel product into a departure confirmation-possible travel product (S110).

Thereafter, as the first travel product (i.e., the departure not-confirmed travel product) is changed into the departure confirmation-possible travel product, the management server 30 provides a predetermined reward to the booking person of the second travel product who has accepted the booking change into the first travel product. The management server 30 also provides a predetermined reward to a booking person who has confirmed the booking about the first travel product in the state in which the booking confirmation date of the first travel product has not been reached (S120).

Although not illustrated in FIGS. 4 and 5, the management server 30 may additionally inquire of the booking person of the second travel product (e.g., a departure confirmation-possible travel product) that is ahead of the booking confirmation date thereof and in which the number of booking persons is the minimum number of departure persons or more about booking confirmation for the second travel product ahead of the booking confirmation date, based on the booking-related information. The management server 30 may receive information including a reply to the inquiry about the booking confirmation from the booking person terminal 10, and may update the number of persons who have confirmed the booking about the second travel product, based on the received information. Furthermore, the management server 30 may provide a predetermined reward to a booking person who has accepted the booking confirmation for the second travel product (e.g., a departure confirmation-possible travel product) ahead of the booking confirmation date.

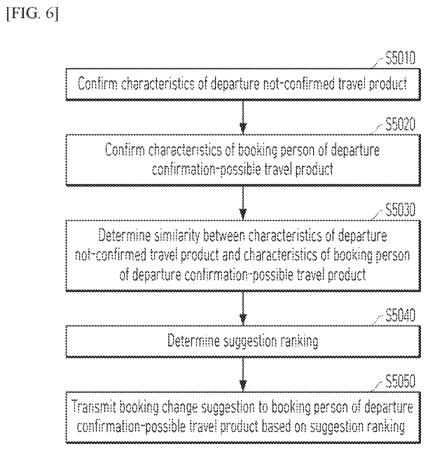

FIG. 6 is a flowchart for more specifically describing a step of transmitting a booking change suggestion in the method of managing the booking of travel products according to an embodiment of the present disclosure.

In step S40, the management server 30 may determine (or search for) several second travel products (e.g., departure confirmation-possible travel products). In this case, it is preferred that priorities of many booking persons are determined and that the booking change suggestion is sequentially transmitted to the booking persons based on the priorities rather than thoughtlessly transmitting the booking change suggestion to the booking persons.

To this end, step S50 may be subdivided as follows. That is, the management server 30 may determine, as a first target, a booking person (i.e., a booking person of the second travel product) who is expected to have the highest possibility that the booking person will accept the booking change suggestion, based on information stored in the memory 34, and may provide the booking change suggestion to the determined first target.

In other words, the management server 30 confirms characteristics of the first travel product (e.g., a departure not-confirmed travel product) based on the information stored in the memory 34 (S5010).

Furthermore, the management server 30 confirms characteristics of booking persons of multiple second travel products (e.g., departure confirmation-possible travel products) (S5020).

Thereafter, the management server 30 determines similarity between the characteristics of the first travel product and the characteristics of the booking persons of the multiple second travel products (S5030). That is, the management server 30 determines a degree that the characteristics of the first travel product are matched with each of the booking persons of the multiple second travel products.

Accordingly, the management server 30 determines suggestion ranking based on the determined similarity (S5040). In this case, it is better that a travel departure date of the second travel product does not have a great difference from a travel departure date of the first travel product. Accordingly, the management server 30 may also incorporate a period between the travel departure date of the second travel product and the travel departure date of the first travel product into the determination of the suggestion ranking.

Thereafter, the management server 30 transmits the booking change suggestion to the booking person of the second travel product based on the suggestion ranking (S5050). That is, the management server 30 determines, as the first target, the booking person of the second travel product, who has the highest similarity, and first transmits the booking change suggestion to the first target. If the first target does not accept the booking change suggestion, the management server 30 has only to transmit the booking change suggestion to a second target having subsequent ranking.

In this case, the acceptance probability for the booking change suggestion can be increased because the booking change suggestion can be sequentially provided from a booking person having the highest possibility that the booking person will accept the booking change suggestion. It is not necessary to thoughtlessly transmit the booking change suggestion to many booking persons at the same time.

Furthermore, the method of managing the booking of travel products according to an embodiment of the present disclosure may also be implemented as a computer-readable code in a computer-readable recording medium. The computer-readable medium includes all types of recording media in which data readable by a computer system is stored. Examples of the computer-readable medium include ROM, RAM, CD-ROM, a magnetic tape, a floppy disk, and an optical data storage device. Furthermore, the computer-readable recording medium may be distributed to computer systems connected over a network so that a computer-readable code can be stored and executed in a distributed manner. Furthermore, functional programs, codes, and code segments for implementing the above method may be easily inferred by programmers of the technical field to which the present disclosure belongs.

The above description is merely a description of the technical spirit of the present disclosure, and those skilled in the art may change and modify the present disclosure in various ways without departing from the essential characteristic of the present disclosure. Accordingly, the embodiments disclosed in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range of the present disclosure should be construed as being included in the scope of rights of the present disclosure.

1. An apparatus for managing a booking of a travel product, the apparatus comprising:
memory configured to store booking-related information comprising information on a booking confirmation date, travel departure date, number of booking persons, number of persons who have confirmed a booking, and minimum number of departure persons of a travel product; and
a processor configured to determine a first travel product that is ahead of a booking confirmation date thereof and in which a number of booking persons is less than a minimum number of departure persons based on the booking-related information, to determine a second travel product that is ahead of a booking confirmation date thereof and in which a number of booking persons is a minimum number of departure persons or more based on the booking-related information, and to provide a booking person of the second travel product with a booking change suggestion indicative of a booking change into the first travel product.

2. The apparatus of claim 1, wherein the processor is configured to change the booking person of the second travel product into the number of booking persons for the first travel product, when receiving an acceptance signal for the booking change suggestion from the booking person of the second travel product.

3. The apparatus of claim 2, wherein the processor is configured to provide a reward to a corresponding booking person who has accepted the booking change suggestion, when a booking confirmation date of the first travel product is reached and a current number of booking persons for the first travel product at a time of the booking confirmation date is the minimum number of departure persons or more.

4. The apparatus of claim 1, wherein:
the booking-related information additionally comprises characteristic information for each travel product, and
the memory is configured to additionally store booking person information and booking history information for each booking person.

5. The apparatus of claim 4, wherein:
the second travel product is multiple, and
the processor is configured to:
determine, as a first target, a booking person who is expected to have a highest possibility that the booking person is to accept the booking change suggestion based on information stored in the memory, and
preferentially provide the booking change suggestion to the determined first target.

6. The apparatus of claim 5, wherein the processor is configured to:
check characteristics of the first travel product,
check characteristics of each of booking persons of multiple second travel products,
determine similarity between the characteristics of the first travel product and the characteristics of each of the booking persons of the multiple second travel products,
determine suggestion ranking for the booking persons based on the determined similarity, and
provide the booking change suggestion to the booking person determined as the first target based on the determined suggestion ranking.

7. The apparatus of claim 6, wherein the processor is configured to additionally incorporate a period between a travel departure date of the determined first travel product and a travel departure date of the determined second travel product into the determination of the suggestion ranking.

8. The apparatus of claim 1, wherein:
the first travel product is multiple, and
the processor is configured to determine a first travel product in which a current number of booking persons does not satisfy a minimum number of departure persons and a difference between the current number of booking persons and the minimum number of departure persons is a minimum, among the multiple first travel products.

9. The apparatus of claim 1, wherein the processor is configured to inquire of a booking person of the determined first travel product about booking confirmation for the first travel product ahead of a booking confirmation date of the first travel product.

10. The apparatus of claim 9, wherein the processor is configured to update a number of persons who have confirmed a booking about the first travel product, when receiving a signal indicative of the booking confirmation for the first travel product from the booking person of the first travel product.

11. The apparatus of claim 9, wherein the processor is configured to provide a reward to a booking person who has accepted the booking confirmation when the booking confirmation date of the first travel product is reached and a current number of booking persons for the first travel product at a time of the booking confirmation date is a minimum number of departure persons or more.

12. A method of managing a booking of a travel product, the method being performed by an apparatus for managing a booking of a travel product and comprising:
storing booking-related information comprising information on a booking confirmation date, travel departure date, number of booking persons, number of persons who have confirmed a booking, and minimum number of departure persons of a travel product;
determining a first travel product that is ahead of a booking confirmation date thereof and in which a number of booking persons is less than a minimum number of departure persons based on the booking-related information;
determining a second travel product that is ahead of a booking confirmation date thereof and in which a number of booking persons is a minimum number of departure persons or more based on the booking-related information; and
providing a booking person of the second travel product with a booking change suggestion indicative of a booking change into the first travel product.
